(19) United States
(12) Patent Application Publication
(10) Pub. No.: US 2026/0004428 A1
(43) Pub. Date: Jan. 1, 2026

(54) RAPID IMAGE SEGMENTATION PIPELINE FOR SCANNING TRANSMISSION ELECTRON MICROSCOPY

(71) Applicant: Northwestern University, Evanston, IL (US)

(72) Inventors: Ankit Agrawal, Evanston, IL (US); Alexandra Lauren Day, Winnetka, IL (US); Carolin Barbara Wahl, Evanston, IL (US); Roberto Moreno Souza dos Reis, Chicago, IL (US); Alok Nidhi Choudhary, Chicago, IL (US); Chad A. Mirkin, Wilmette, IL (US); Vinayak P. Dravid, Glenview, IL (US)

(21) Appl. No.: 19/207,977

(22) Filed: May 14, 2025

Related U.S. Application Data
(60) Provisional application No. 63/665,529, filed on Jun. 28, 2024.

(51) Int. Cl. G06T 7/11; G06V 10/25

(52) U.S. Cl. CPC G06T 7/11; G06V 10/25; G06T 2207/10061; G06T 2207/20132

(57) ABSTRACT

A system to perform image processing and segmentation includes a memory configured to store an image of a nanoparticle. The system also includes a processor operatively coupled to the memory. The processor is configured to identify a background of the image, where the background includes one or more portions of the image that do not depict the nanoparticle. The processor removes the background from the image with a mask. The processor applies clustering to the image to identify regions of interest in the image. The processor also identifies acquisition boxes in each of the identified regions of interest.

### CROSS-REFERENCE TO RELATED APPLICATION

The present application claims the priority benefit of U.S. Provisional Patent App. No. 63/665,529 filed on Jun. 28, 2024, the entire disclosure of which is incorporated by reference herein.

### REFERENCE TO GOVERNMENT RIGHTS

This invention was made with government support under grant numbers CMMI2053929, DGE2234667, DMR2308691, ECCS2025633 and OAC2331329 awarded by the National Science Foundation and grant number DE-SC0021399 awarded by the Department of Energy and grant number 70NANB 19H005 awarded by the National Institute of Standards and Technology and grant number W911NF-23-1-0141 awarded by the Army Research Office. The government has certain rights in the invention.

### BACKGROUND

The characterization of nanoparticles, also referred to as nanoparticle characterization, is a branch of nanometrology that involves measurement and analysis of the physical and chemical properties of nanoparticles. Nanoparticles are characterized for various purposes, including nanotoxicology studies to assess health risks, as well as manufacturing process control. By definition, nanoparticles measure less than 100 nanometers in at least one of their external dimensions, and therefore cannot be examined by the naked eye. Additionally, nanoparticles are unlike conventional chemicals in that their chemical composition and concentration are not sufficient metrics for a complete description, because they vary in other physical properties such as size, shape, surface properties, crystallinity, and dispersion state. Therefore, special techniques are utilized to perform nanoparticle characterization, such as microscopy, spectroscopy, etc.

### SUMMARY

An illustrative system to perform image processing and segmentation includes a memory configured to store an image of a nanoparticle. The system also includes a processor operatively coupled to the memory. The processor is configured to identify a background of the image, where the background includes one or more portions of the image that do not depict the nanoparticle. The processor removes the background from the image with a mask. The processor applies clustering to the image to identify regions of interest in the image. The processor also identifies acquisition boxes in each of the identified regions of interest.

In another embodiment, the processor determines a cutoff value, where the background of the image is identified based on the cutoff value. In another embodiment, the processor analyzes pixel intensities of the image, wherein the cutoff value is determined based on the pixel intensities. In another embodiment, the pixel intensities are determined along a line that runs diagonally across the image.

In one embodiment, the mask comprises an updated binary mask. In another embodiment, the processor determines a convex hull of an original binary mask for the image, and the updated binary mask is generated based on the convex hull of the original binary mask. In another embodiment, the processor applies a sharpening mask to a resized version of the image, and the processor applies a Gaussian threshold to the blurred image to generate the original binary mask. In another embodiment, the processor brightens a foreground of the image based on an intensity range of the image. In another embodiment, the processor applies Gaussian thresholding to the image to generate a bounding box for the nanoparticle, and the processor crops the image based on the bounding box. In another embodiment, the clustering comprises k-means clustering, and the clustering is performed based on a number of intensity peaks identified in the image.

In another embodiment, the acquisition boxes comprise squares that completely fill each of identified regions of interest. In another embodiment, the system uses the acquisition boxes to determine acquisition coordinates for analysis of the nanoparticle. In another embodiment, the system includes a scanning transmission electron microscope in communication with the processor, where the scanning transmission electron microscope uses the acquisition coordinates to generate a characterization of the nanoparticle.

An illustrative method of performing image processing and segmentation includes storing, in a memory of a computing system, an image of a nanoparticle. The method also includes identifying, by a processor of the computing system, a background of the image, where the background includes one or more portions of the image that do not depict the nanoparticle. The method also includes removing, by the processor, the background from the image with a mask. The method also includes applying, by the processor, clustering to the image to identify regions of interest in the image. The method further includes identifying, by the processor, acquisition boxes in each of the identified regions of interest.

In one embodiment, the method includes determining, by the processor, a cutoff value, where the background of the image is identified based on the cutoff value. In another embodiment, the method includes analyzing, by the processor, pixel intensities of the image, where the cutoff value is determined based on the pixel intensities. In another embodiment, the method includes determining, by the processor, the pixel intensities along a line that runs diagonally across the image. In another embodiment, the method includes determining, by the processor, a convex hull of an original binary mask for the image, and generating an updated mask based on the convex hull of the original binary mask. In another embodiment, the method includes applying, by the processor, Gaussian thresholding to the image to generate a bounding box for the nanoparticle, and cropping the image based on the bounding box. In another embodiment, the clustering comprises k-means clustering, and the method further includes performing the clustering based on a number of intensity peaks identified in the image. In another embodiment, the method includes determining, based on the acquisition boxes, acquisition coordinates for analysis of the nanoparticle. In another embodiment, the method includes generating, by a scanning transmission electron microscope in communication with the processor and based on the acquisition coordinates, a characterization of the nanoparticle.

Other principal features and advantages of the invention will become apparent to those skilled in the art upon review of the following drawings, the detailed description, and the appended claims.

### BRIEF DESCRIPTION OF THE DRAWINGS

Illustrative embodiments of the invention will hereafter be described with reference to the accompanying drawings, wherein like numerals denote like elements.

FIG. 1A depicts an original parent image in accordance with an illustrative embodiment.

FIG. 1B depicts a manually created image representing the desired outcome after performing a background removal operation in accordance with an illustrative embodiment.

FIG. 1C depicts a manually created image representing ideal segmentation regions for the parent image in accordance with an illustrative embodiment.

FIG. 1D depicts acquisition boxes corresponding to the locations of features of interest in accordance with an illustrative embodiment.

FIG. 2A depicts an original image of a nanoparticle in accordance with an illustrative embodiment.

FIG. 2B depicts the original image resized to 128×128 pixels in accordance with an illustrative embodiment.

FIG. 2C depicts a sharpening mask applied to the image of FIG. 2B in accordance with an illustrative embodiment.

FIG. 2D depicts a Gaussian Blur applied to the image of FIG. 2C in accordance with an illustrative embodiment.

FIG. 2E depicts the binary mask resulting from Gaussian thresholding on the image of FIG. 2D, overlaid by a bounding box in accordance with an illustrative embodiment.

FIG. 2F depicts the image of FIG. 2B cropped to the coordinates of the bounding box in FIG. 2E in accordance with an illustrative embodiment.

FIG. 3A depicts a cropped image with the diagonal overlaid in accordance with an illustrative embodiment.

FIG. 3B depicts a plot of the pixel intensities along this diagonal, with the cutoff value as a horizontal line in accordance with an illustrative embodiment.

FIG. 3C is a histogram of the difference in intensity values between the upper-left-to-lower-right and upper-right-to-lower-left diagonals across the entire dataset in accordance with an illustrative embodiment.

FIG. 4A depicts a cropped image in accordance with an illustrative embodiment.

FIG. 4B depicts a binary mask of FIG. 4A after removal of the background in accordance with an illustrative embodiment.

FIG. 4C depicts a convex hull of FIG. 4B in accordance with an illustrative embodiment.

FIG. 4D depicts the result of filtering FIG. 4A based on the mask in FIG. 4C and brightening the foreground by the amount in Equation 1 in accordance with an illustrative embodiment.

FIG. 5 depicts a process that identifies one pixel intensity peak for the nanoparticle shown in FIGS. 2-4 in accordance with an illustrative embodiment.

FIG. 6A depicts a cropped image of a nanoparticle after a sharpening step and a blurring step have been applied to the image in FIG. 4D in accordance with an illustrative embodiment.

FIG. 6B depicts the result of applying k-means clustering with k=5 to the cropped image of FIG. 6A in accordance with an illustrative embodiment.

FIG. 7 depicts the first algorithm used to perform box segmentation in accordance with an illustrative embodiment.

FIG. 8 depicts the second algorithm used to perform box segmentation in accordance with an illustrative embodiment.

FIG. 9A depicts acquisition boxes on an image of a nanoparticle that are calculated using Algorithm 2, overlaid on the segmentation result of FIG. 6 in accordance with an illustrative embodiment.

FIG. 9B depicts the acquisition boxes of FIG. 9A overlaid on a cropped image of the nanoparticle in accordance with an illustrative embodiment.

FIG. 10 depicts a histogram of the median processing times for the dataset, when each image is run 30 times in accordance with an illustrative embodiment.

FIG. 11 depicts the distribution of the number of calculated boxes across the entire dataset in accordance with an illustrative embodiment.

FIG. 12 depicts projected total time to process and acquire images, using Equation 4, for benchmark acquisition methods ranging from 8 s to 64 s in accordance with an illustrative embodiment.

FIG. 13 is a table that depicts the current baseline to the projected process time using the proposed system in accordance with an illustrative embodiment.

FIG. 14 depicts a computing device in direct or indirect communication with a network in accordance with an illustrative embodiment.

### DETAILED DESCRIPTION

Nanoparticle characterization is rapidly becoming a “big data” problem, where the volume of data threatens to surpass the capabilities of analytical approaches. Recent developments have made it possible to synthesize vast arrays with millions of distinct nanoparticles on a chip, known as combinatorial megalibraries. Manual analysis can no longer fully capture the abundance of information contained in these arrays, leading to a bottleneck in processing. To meet the challenge posed by high throughput characterization, researchers are increasingly turning to automated tools and analysis frameworks. Recently, machine learning (ML), deep learning (DL), and artificial intelligence (AI) have become valuable tools in materials science. Researchers are compiling databases and libraries of material properties and developing analysis frameworks that leverage the power of AI, which are increasingly driving materials design and discovery.

Described herein are methods and systems to automate key steps in nanoparticle characterization. As used herein, characterization refers to structural characterization, in particular image segmentation for more informed data acquisition. The high-fidelity techniques that could benefit from the proposed methods and systems include scanning probe-based microscopy characterization techniques (for example, Scanning Electron Microscopy (SEM), Scanning Transmission Electron Microscopy (STEM), Scanning Tunneling Microscopy (STM), Atomic Force Microscopy (AFM), Scanning Force Microscopy (SFM), or probe-based X-ray mapping (Scanning Transmission X-ray absorption spectroscopy (STXAS)), and more). Any application that requires input from a segmented image where we can direct a probe to specific set of coordinates. These techniques incorporate structural, functional, and chemical characterization. Additionally, in medical applications, STM techniques could benefit from the proposed methods and systems.

In one embodiment, a first operation includes a quality assessment to determine if a particle meets the criteria for further analysis. In previous work, the inventors built binary classification machine learning models for this task. Once a particle has been selected for in-depth study, researchers can choose where within the particle to gather data. As discussed in more detail below, this operation is automated with a custom pipeline that returns acquisition coordinates for STEM-based analysis, such as Four-Dimensional Scanning Transmission Electron Microscopy (4D-STEM), Energy Dispersive X-ray Spectroscopy (EDS), and Electron Energy Loss Spectroscopy (EELS). The process incorporates techniques from computer vision and unsupervised learning and was carefully designed and tested with input from microscopy and materials science experts. The methods described herein accelerate the characterization workflow by more than 25 times on average, validated using a unique dataset of 964 grayscale nanoparticle images. The pipeline is specifically designed for high-throughput acquisition to enable precise and efficient analysis of material properties at the nanoscale.

Current characterization workflows face significant efficiency limitations. Standard approaches collect high-resolution information using an evenly spaced grid of 128×128 points, dividing each image into 16,384 smaller square regions for analysis. This grid-based approach presents several challenges: it produces regions of identical size regardless of feature complexity, fails to distinguish between particle and background areas, and leads to inefficient use of both time and data storage resources. An optimized preprocessing method should, therefore, accomplish three key objectives: 1) background identification and removal; 2) automated image segmentation based on key features; and 3) appropriate placement of acquisition boxes.

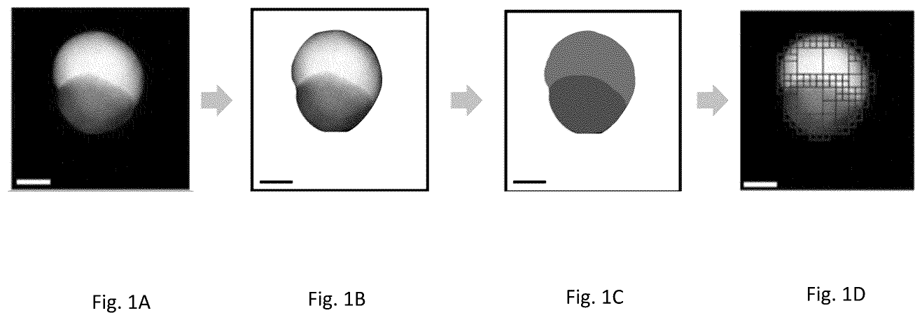

FIG. 1 illustrates this desired workflow. Specifically, FIG. 1A depicts an original parent image in accordance with an illustrative embodiment. FIG. 1B depicts a manually created image representing the desired outcome after performing a background removal operation in accordance with an illustrative embodiment. FIG. 1C depicts a manually created image representing ideal segmentation regions for the parent image in accordance with an illustrative embodiment. FIG. 1D depicts acquisition boxes corresponding to the locations of features of interest in accordance with an illustrative embodiment. In an illustrative embodiment, the acquisition box size corresponds to the locations of features of interest such that areas of varying intensity are captured with smaller boxes. In FIG. 1, the scale bars are 20 nm. As used herein, the original microscopy image is referred to as the “parent image,” and the smaller derivative images as “child images.” The term “acquisition box” describes the set of square coordinates that defines each child image's position within a parent frame (scc FIG. 1).

Modern image analysis often involves techniques from ML and computer vision. When training an ML model, researchers sometimes perform feature engineering steps to provide the model with additional information. These steps may include transformations, such as binning numerical data, or augmentations, such as adding information about visual features in images. Deep learning is a subset of machine learning that relies on many-layer (“deep”) neural networks and large amounts of training data. Deep learning can be advantageous because it can often learn patterns using simpler representations than those required for machine learning. While DL has demonstrated considerable success in a variety of fields, including materials science, computer vision, medicine, physics, and others, the requirement for large amounts of training data can present a challenge.

Image segmentation involves partitioning images into regions of interest. Various ML and DL approaches have proved successful at this task, from convolutional neural networks (CNNs) to specialized architectures like U-net. Specialized training and testing datasets to support image segmentation have been developed, such as Cityscapes, SYNTHIA, COCO, ADE20K, and the LIVECell dataset.

In microscopy and materials science, ML and DL methods have emerged as crucial tools for materials characterization. Segmentation models have been used to detect defects in steel using STEM images and characterize X-ray computed tomography data of sintered alloys. Notable advances include the development of multiple output convolutional networks for multi-particle boundary detection, comprehensive architecture comparisons for TEM image segmentation, and genetic algorithm-based approaches for rapid morphological analysis. These developments demonstrate the field's progression toward automated analysis, though most focus on post-acquisition processing rather than acquisition optimization, which is the focus of this current work.

The initial approach considered traditional ML or DL image segmentation techniques. However, several key factors led the inventors to explore more efficient alternatives. First, the grayscale nanoparticle images differ substantially from common ML datasets, which typically are color images with complex scenes. This distinction made direct adaptation of existing ML models impractical. While supervised transfer learning offered a potential solution for adapting existing models to the domain, the absence of ground-truth segmentation labels in the dataset and the prohibitive cost of creating them made this approach infeasible.

These constraints led the inventors to explore unsupervised learning methods, specifically 1D k-means clustering. This approach offers several advantages: it groups similar data points without requiring labels, has well-established implementations in multiple libraries, and maintains computational efficiency. This choice aligns with recent trends in automated microscopy analysis, where unsupervised methods have shown promise in handling specialized scientific data.

For dividing segmented regions into acquisition boxes, the inventors initially investigated geometric meshing techniques. However, two significant limitations emerged: first, standard meshing algorithms typically generate triangular grids, incompatible with the requirement for square acquisition boxes; second, advanced adaptive refinement features often come embedded in comprehensive software suites, introducing unnecessary dependencies and potential performance overhead. These considerations led to the development of custom methods for generating acquisition coordinates, as discussed below.

The pipeline described herein bridges the gap between initial microscopy imaging and high-resolution analysis techniques. The system generates adaptively-sized acquisition coordinates based on pixel intensity, optimizing data collection for regions of interest while minimizing unnecessary sampling. The approach complements the development of other automated approaches in this field, and is expected to accelerate the characterization process. The implementation maintains high performance with minimal dependencies, ensuring versatility and longevity.

Throughout development of the proposed systems and methods, the inventors relied on a unique set of high-angle annular dark-field (HAADF) images for development and evaluation. The images were acquired specifically to support the development of automated materials characterization. Data were collected on three dates using a JEOL JEM-ARM200CF scanning transmission electron microscope to mimic diverse laboratory conditions. The images were curated to represent a range of magnification levels and materials compositions, from one to five elements.

In one embodiment, the first operation in the overall nanoparticle characterization workflow involves a quality assessment. As such, each image in the dataset was analyzed by a human expert and labeled either “good” or “bad.” These labels correspond to whether or not the expert would choose to further analyze the particle under normal experimental conditions. These labels allowed for training of ML models in previous work to automate the initial quality assessment. Additional metadata in the file names provides unique identifiers for each image.

This work emulates the characterization operation immediately following the quality check, where a particle has passed the assessment and been selected for in-depth analysis. As a result, the inventors chose to filter the comprehensive dataset down to only the images that would reach this stage in the characterization workflow. Using the unique labels provided for each image, the system focused on images labeled “good” with magnifications at or above 1,500,000×, resulting in a final dataset of 964 images for this work. The images were distributed across the three source datasets: 204 from the first, 399 from the second, and 361 from the third.

In an illustrative embodiment, the proposed pipeline includes three major components: image preprocessing, clustering, and acquisition box generation. Each component was developed with careful consideration of computational efficiency and effectiveness across diverse sample conditions. The following sections detail the procedures and design decisions for each operation.

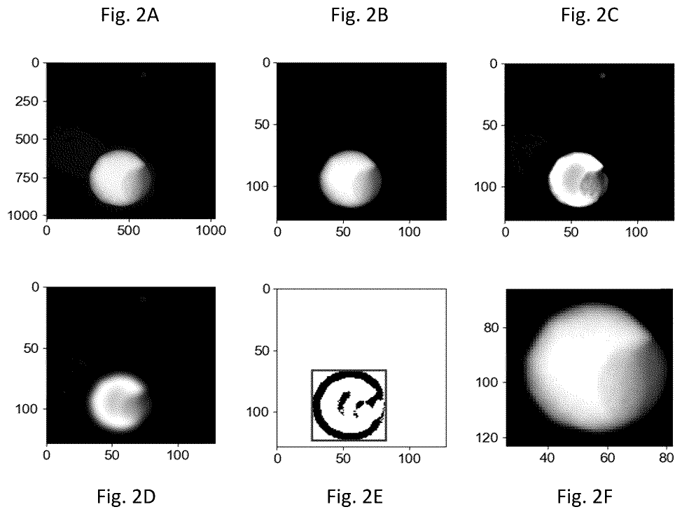

Image preprocessing operations are depicted in FIG. 2. FIG. 2A depicts an original image of a nanoparticle in accordance with an illustrative embodiment. FIG. 2B depicts the original image resized to 128×128 pixels in accordance with an illustrative embodiment. FIG. 2C depicts a sharpening mask applied to the image of FIG. 2B in accordance with an illustrative embodiment. FIG. 2D depicts a Gaussian Blur applied to the image of FIG. 2C in accordance with an illustrative embodiment. FIG. 2E depicts the binary mask resulting from Gaussian thresholding on the image of FIG. 2D, overlaid by a bounding box in accordance with an illustrative embodiment. FIG. 2F depicts the image of FIG. 2B cropped to the coordinates of the bounding box in FIG. 2E in accordance with an illustrative embodiment. The composition of this nanoparticle is Au₄₀Ag₁₀Cu₁₀Ni₄₀. The original image, shown in FIG. 2A, has a magnification of 1,500,000× and a resolution of 1024×1024 pixels.

Still referring to FIG. 2, the first operation in the pipeline involves downsizing the parent image to 128×128 pixels. This operation provides a direct comparison with the existing 128×128 grid technique and allows one to standardize inputs across datasets (parent images have original resolutions of either 512×512 or 1024×1024, depending on the collection date). The downsizing operation is illustrated in FIG. 2B.

Next, the image is cropped to remove the background and center the nanoparticle in the foreground. This operation creates a smaller image, significantly reducing processing time. To prepare the image for cropping, the inventors applied image enhancement techniques to reduce noise and highlight features. First, a sharpening mask is applied to the image (FIG. 2C), followed by a GaussianBlur filter (FIG. 2D) and an adaptive Gaussian threshold. This last operation produces a binary mask with foreground and background regions, allowing one to calculate a bounding box that fully encloses the foreground pixels (FIG. 2E). Finally, the original 128×128 image is cropped to the region enclosed by the bounding box, yielding a focused region of interest (FIG. 2F).

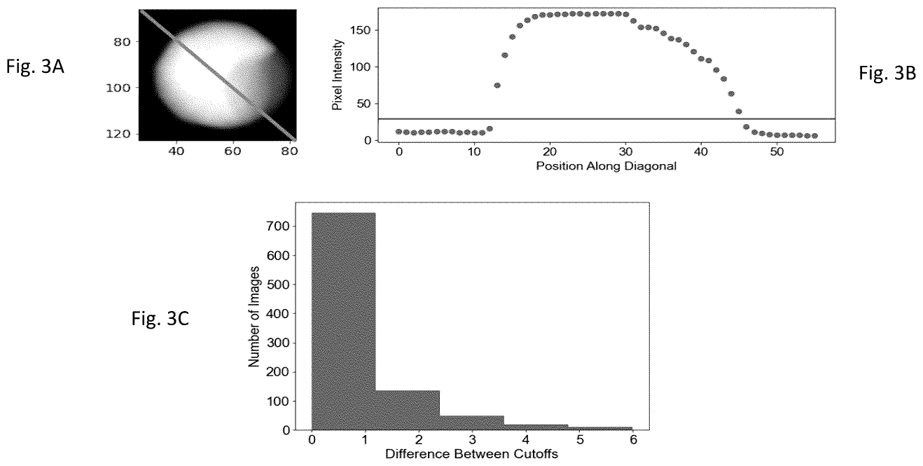

An additional operation was performed to further separate the foreground from the remaining background. Specifically, the pixel intensity is plotted along the upper-left-to-lower-right diagonal in the cropped image, resulting in a profile that varies along with features in the image (FIG. 3A). Alternatively, a different diagonal line may be used initially, such as upper-right to lower-left. A cutoff is then computed using information from the profile slope and total intensity range (FIG. 3B). During the design process, the same technique was implemented with the lower-left-to-upper-right diagonal, resulting in a second cutoff value. However, the differences between the two cutoffs were trivial in most cases (FIG. 3C), so only information from the upper-left-to-lower-right diagonal was used to streamline the process. FIG. 3A depicts a cropped image with the diagonal overlaid in accordance with an illustrative embodiment. FIG. 3B depicts a plot of the pixel intensities along this diagonal, with the cutoff value as a horizontal line in accordance with an illustrative embodiment. FIG. 3C is a histogram of the difference in intensity values between the upper-left-to-lower-right and upper-right-to-lower-left diagonals across the entire dataset in accordance with an illustrative embodiment.

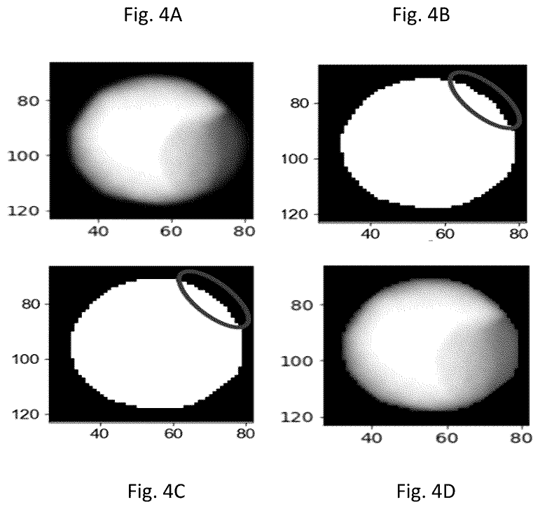

Once the cutoff is calculated, the pixel values in the cropped image below the cutoff are set to 0, corresponding to the background, and the remaining pixels, the foreground, are set to 1. This process produces a binary mask in the shape of the outline of the particle. FIG. 4A depicts a cropped image in accordance with an illustrative embodiment. FIG. 4B depicts a binary mask of FIG. 4A after removal of the background in accordance with an illustrative embodiment.

In one embodiment, the nanoparticles in the application are always convex, which prompts an additional check at this operation. First, the convex hull of the binary mask is calculated (FIG. 4C). This operation returns a new binary mask that corrects any undesirable concavity in the original mask. This mask is then used to remove the background in the cropped image. The pixel locations in the cropped image corresponding to the mask background are set to 0, and the foreground pixels are brightened slightly to further differentiate them from the background. FIG. 4C depicts a convex hull of FIG. 4B in accordance with an illustrative embodiment. FIG. 4D depicts the result of filtering FIG. 4A based on the mask in FIG. 4C and brightening the foreground by the amount in Equation 1 in accordance with an illustrative embodiment. It is noted that the ovals in FIGS. 4B and 4C highlight the difference between the binary mask and the convex hull. The amount by which the foreground is brightened is relative to the intensity range of the diagonal, as shown in Equation 1 below. Following these operations, the image is sharpened and blurred using the same techniques as before.

$$Foreground Offset = Ceiling ( Range ( Diagonal Pixel Intensities ) * 0.2 \qquad Eq . 1$$

In an illustrative embodiment, 1D k-means clustering is used for image segmentation. It is therefore important to estimate the number of clusters in the image as precisely as possible. The inventors experimented with several techniques and converged on a strategy that combines information about the number of elements in the particle composition and the peak pixel intensities in the image. This approach allows one to make use of chemical information specific to each particle. Looking ahead, this approach could be extended to novel materials compositions.

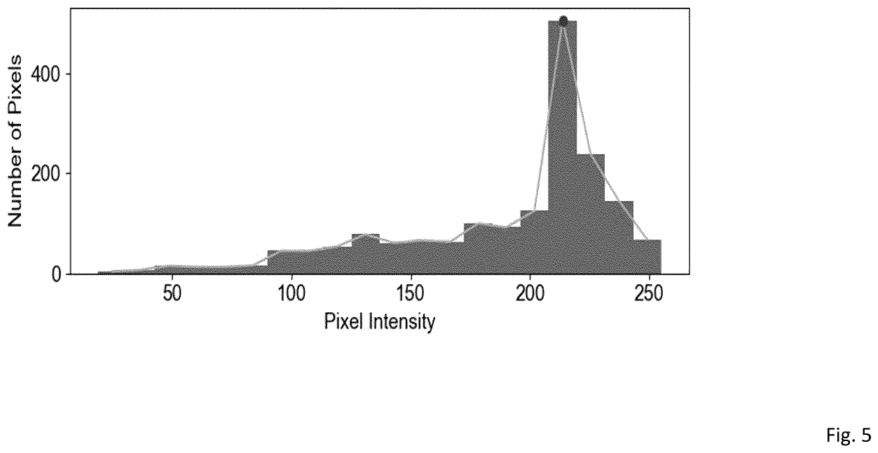

The inventors used a histogram and scipy's find_peaks tool to estimate the number of pixel intensity peaks. Since values of 0 correspond to the background and are not meaningful for this operation, they were removed from the histogram. A bin size of 20 was used, and criteria was set to capture any peak with a prominence greater than 5% of the maximum value on the y-axis. FIG. 5 depicts a process that identifies one pixel intensity peak for the nanoparticle shown in FIGS. 2-4 in accordance with an illustrative embodiment.

Higher k values result in longer segmentation times, so it is important to identify the lowest possible k values that would produce reasonable segmentations. To find a good value of k for each image, one can combine information about the number of peaks (p) calculated using the histogram and the number of elements (n) in the composition. The procedure uses the following logic:

Procedure 1:

If (p < 2) or (abs(p−n) >= 2):
k = n + 1
Else:
k = p + 1

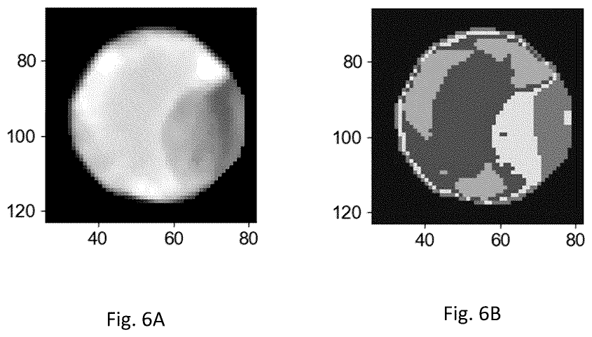

One can then use the resulting k value to segment an image using 1D k-means clustering. FIG. 6A depicts a cropped image of a nanoparticle after preprocessing steps in accordance with an illustrative embodiment. FIG. 6B depicts the result of applying k-means clustering with k=5 to the preprocessed image of FIG. 6A in accordance with an illustrative embodiment.

The inventors implemented two different algorithms for creating acquisition boxes. One approach involved finding and prioritizing the largest possible non-overlapping boxes within a given segmented region. The second approach was more efficient but did not prioritize the largest squares. The first strategy is described in Algorithm 1, and the second in Algorithm 2:

### Algorithm 1:

Description: Returns a list of squares T that completely fill some segmented region R inside an image array A, except the background region. Sorts the squares to prioritize the largest non-overlapping boxes. Each element of T contains upper-left-hand coordinates x, y and size s.

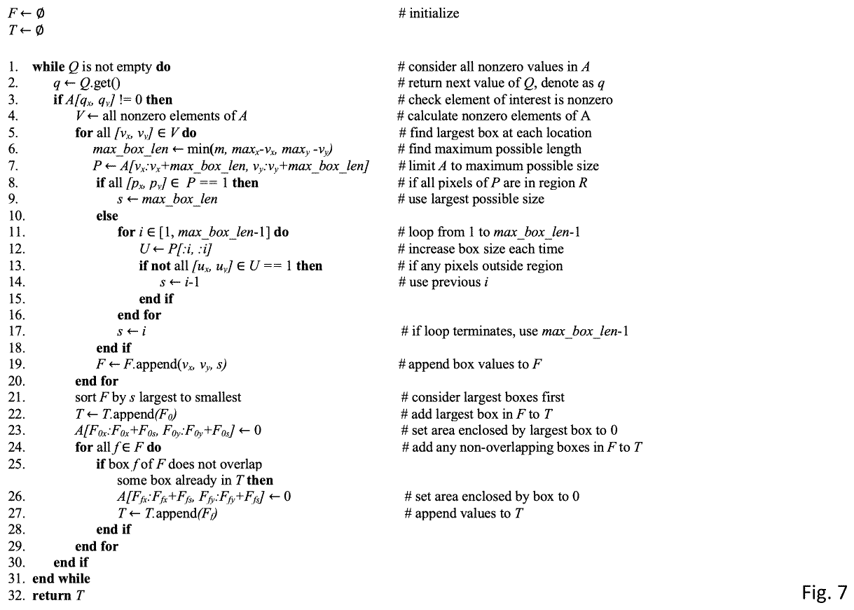

Input: A, a mask array the same size as the image; for some given element a∈A, a=1 if the pixel at that location ∈R; 0 otherwise. Let the element at position x, y be denoted A[x, y]. Let the lower-right-hand corner of A be denoted as A[maxₓ, max_{y}]. Let Q be a queue containing the x and y coordinates of all initial nonzero values of A, where the order of the coordinates is the same as when iterating across columns and then down rows of A. The maximum allowed box size is specified as m. FIG. 7 depicts the first algorithm used to perform box segmentation in accordance with an illustrative embodiment.

### Algorithm 2:

Description: Returns a list of squares F that completely fill some segmented region R inside an image array A, except the background region. Each element of F contains upper-left-hand coordinates x, y and size s.

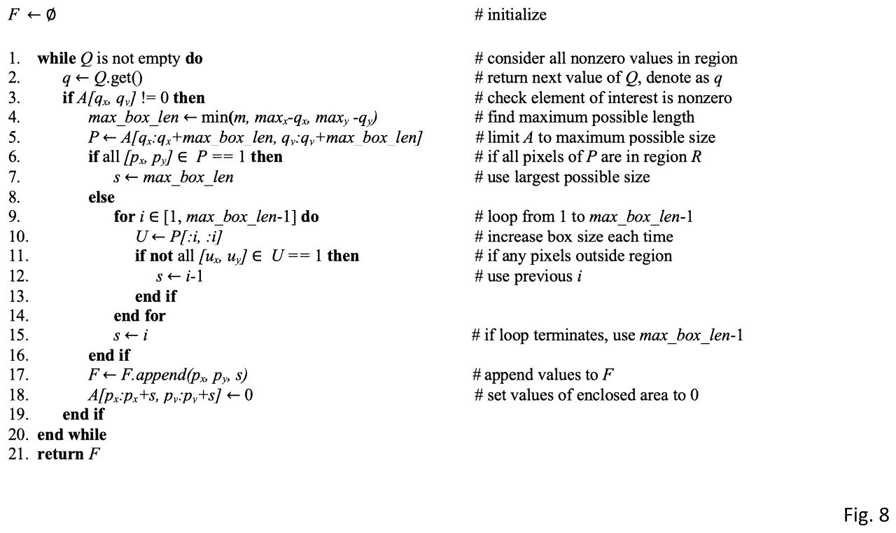

Input: A, a mask array the same size as the image; for some given element a∈A, a=1 if the pixel at that location ∈R; 0 otherwise. Let the element at position x, y be denoted A[x, y]. Let the lower-right-hand corner of A be denoted as A[maxₓ, max_{y}]. Let Q be a queue containing the x and y coordinates of all initial nonzero values of A, where the order of the coordinates is the same as when iterating across columns and then down rows of A. The maximum allowed box size is specified as m. FIG. 8 depicts the second algorithm used to perform box segmentation in accordance with an illustrative embodiment.

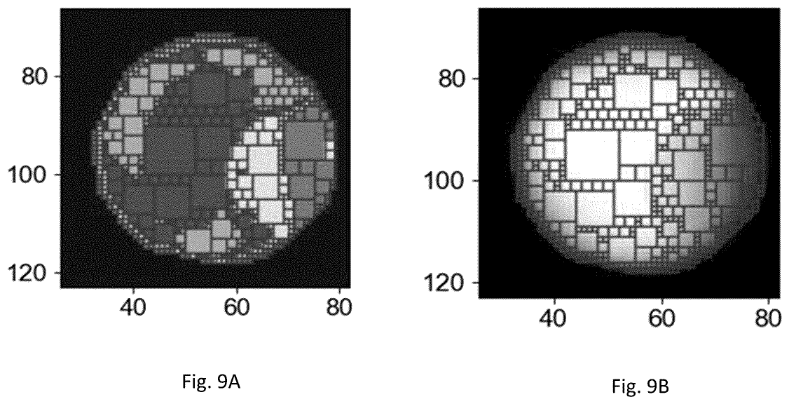

In an illustrative embodiment, the size of the maximum possible box was capped to 20% of the shorter side of the cropped image. For example, a cropped image of size 100×80 pixels would contain acquisition boxes up to a maximum size of 80*0.2=16 pixels. Setting this upper bound allowed for standardization of the results, and also prevented detail loss in large images. It also made Algorithm 2 the applicable choice for this application, although it is noted that Algorithm I may be the preferred choice in other situations. Algorithm 2 was used for the results discussed below. FIG. 9A depicts acquisition boxes on an image of a nanoparticle that are calculated using Algorithm 2, overlaid on the segmentation result of FIG. 6 in accordance with an illustrative embodiment. FIG. 9B depicts the acquisition boxes of FIG. 9A overlaid on a cropped image of the nanoparticle in accordance with an illustrative embodiment.

To summarize, the following is a list of the 15 major preprocessing operations performed by the system: 1). Load the original image, 2). Resize the image from operation 1, 3). Sharpen the image from operation 2, 4). Blur the resulting image from operation 3, 5). Apply Gaussian thresholding to the image from operation 4 (this produces foreground and background regions), 6). Find the boundaries of the foreground region from operation 5 and use these boundaries to crop the image from operation 2, 7). Use the cropped image from operation 6 and information about the pixel intensities along the diagonal to calculate a cutoff value to separate the foreground from the background, 8). Use the cutoff value from operation 7 to create an “original” binary mask of the image from operation 6 (one region represents the foreground, the other represents the background, and it is noted that this is a different foreground and background than the ones in operation 5, 9). Calculate the convex hull of the foreground mask from operation 8 to create an “updated” binary mask, 10). Use the cropped image from operation 6 and the updated mask from operation 9 to set the background region of the cropped image to 0, and also brighten the foreground region by the amount in Equation 1, 11). Sharpen the image from operation 10, 12). Blur the image from operation 11, 13). Estimate the number of intensity peaks for the image from operation 12 using the histogram technique (this provides the k-value for segmentation), 14). Perform segmentation on the image from operation 12 using the k-value from operation 13, and 15). Calculate acquisition boxes using the algorithms applied to the output of the segmentation operation (i.e., operation 14).

After the final design decisions were made, the inventors ran the code on all 964 images in the dataset. Timing information from these experiments was then gathered and a visual inspection of the results was performed.

To standardize the segmentation results on successive code runs, the inventors set a random seed and verified that the segmentation and boxing results were unchanged between runs when the seed was applied. Python's cProfiler was used to identify performance bottlenecks and allowed the inventors to achieve significant speedups between successive versions of the code. The timing tests described below were conducted on a 2020 MacBook Pro, running macOS Sonoma 14.5. In alternative embodiments, different hardware and/or software may be used.

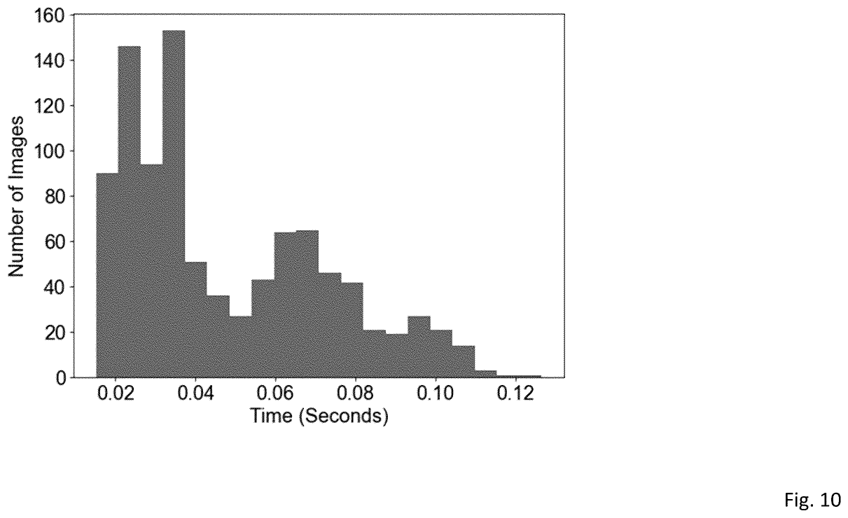

To account for timing variability, the code was run on each image 30 times while calculating the elapsed processing time. The median of those 30 values was then calculated for each image. In the following calculations, the distribution of these median values across the entire dataset was examined. The average of the median image processing times across the entire dataset was 0.05 s, with a maximum of 0.13 s and a minimum of 0.02 s. The median value was 0.04 s. FIG. 10 depicts a histogram of the median processing times for the dataset, when each image is run 30 times in accordance with an illustrative embodiment. In other words, the inventors processed each image 30 times, then calculated the median processing time for that image. FIG. 10 shows the distribution of median times over the entire dataset. This processing time includes the preprocessing, segmentation, and box calculation operations.

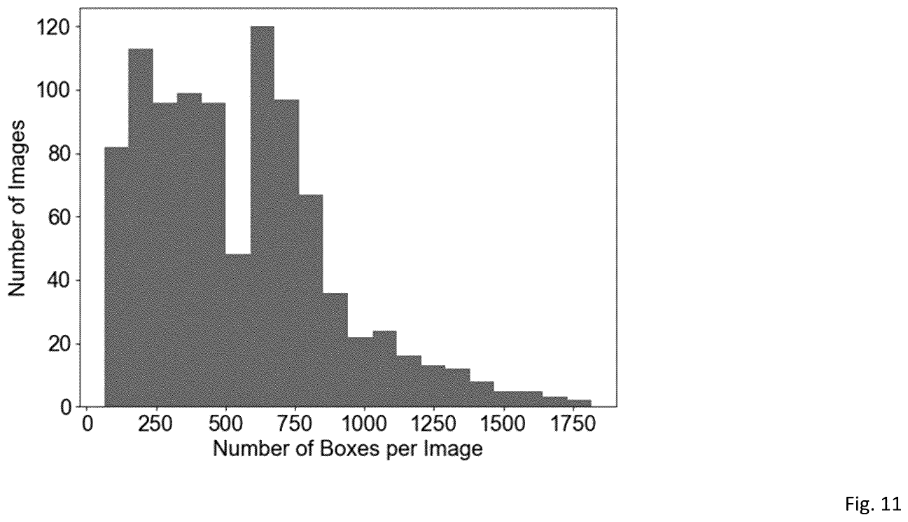

Because the random seed guarantees that segmentation and boxing results are the same every time, the number of boxes calculated on a single run of the code was reported. The number of boxes varied between 63 and 1819, with a mean value of 551.2 and a median of 493.0. Since the original procedure captured 16,384 child images for each parent image, the process results in 9.0 times fewer boxes in the worst-case scenario, 260.1 times fewer in the best case, and 29.7 times fewer in the average case. This streamlined process saves time and data storage space. FIG. 11 depicts the distribution of the number of calculated boxes across the entire dataset in accordance with an illustrative embodiment.

To benchmark the process, one can calculate the projected total time needed to process an image and capture 4D-STEM data using known laboratory acquisition times. For an image, one can represent the total time to process and acquire data using Equation 2, where T is the total time, t_{seg} is the time for the segmentation and boxing process, no is the number of boxes, and t_{acq} is the projected acquisition time per data point.

$$T = {t}_{seg} + {n}_{b} * {t}_{acq} \qquad Eq . 2$$

The benchmark 4D-STEM acquisition methods take 8, 16, 32, and 64 s for a single image and capture 16,834 individual data points. It was calculated that it takes

$${t}_{acq} = \frac{{s}_{b}}{16 , 384}$$

to acquire a single data point, where sb is a known benchmark time. For example, given a current acquisition process that takes 8 s per image, one can calculate

$${t}_{acq} = \frac{8 seconds}{16 , 384 points} = 0.488 ms per data point .$$

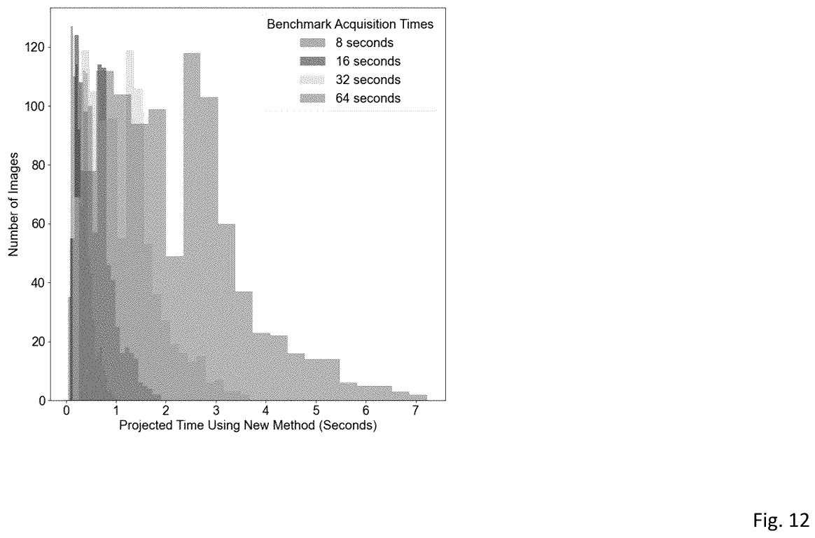

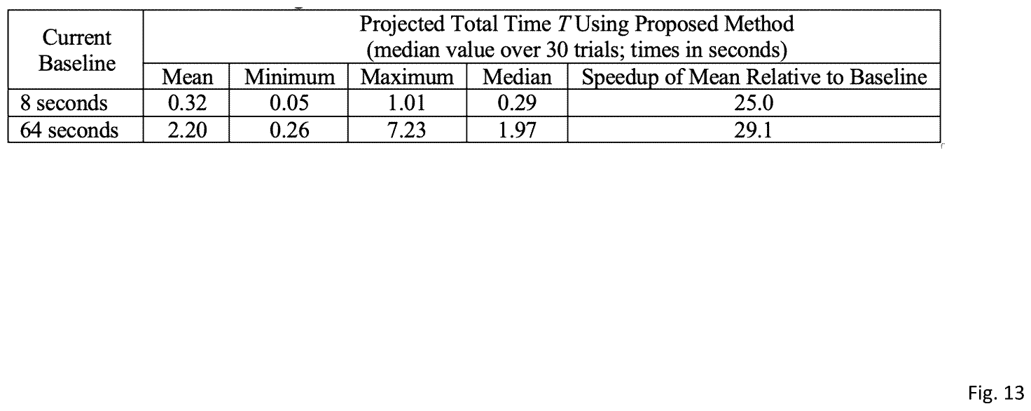

To show how the speedup changes for each of these values, the distribution of T expected for each of these values was calculated. FIG. 12 depicts the projected total time to process and acquire images, using Equation 2, for benchmark acquisition methods ranging from 8 s to 64 s in accordance with an illustrative embodiment. For these calculations, the inventors again used the median timing value over 30 trials for each image and then calculated statistics across the entire dataset. FIG. 13 is a table that depicts the current baseline to the projected process time using the proposed system in accordance with an illustrative embodiment.

It is noted that the acquisition time portion (n_{b}*t_{acq}) dominates the total projected runtimes, and the proposed preprocessing, segmentation, and boxing time (t_{seg}) is a relatively insignificant component of the total. Note that t_{seg} is independent of the baseline acquisition method, i.e., it is the same for both the 8 s and 64 s baselines.

Running the code on the dataset generates 964 distinct pipeline results, which were used to evaluate overall performance. The following criteria was used to judge each image: (1) the bounding box should fully enclose the entire particle, including any faint edges; (2) the segmentation step should separate any areas in the image that differ in pixel intensity; (3) the returned acquisition boxes should reflect regions of interest within the original image. Using these metrics, the inventors performed a visual inspection on a single run of the code. The inventors identified 925 of the final images as meeting all criteria, providing an overall success rate of 96.0%.

Thus, described herein is an efficient, automated image segmentation pipeline that addresses a critical bottleneck in high-throughput nanoparticle characterization. The pipeline is expected to process images 25.0 to 29.1 times faster than baseline methods and operates without human input. The results of the pipeline were evaluated on over 900 diverse images and resulted in a 96.0% success rate based on expert-validated criteria. The system effectively handles variations in focus, magnification, and contrast, demonstrating robust performance across different experimental conditions. Moreover, the approach is expected to reduce the number of acquisition points by an average factor of 29.7, significantly saving storage space. The pipeline's distinctive features include adaptive sizing of acquisition boxes and integration of particle composition information in the segmentation process. The code was optimized for speed and designed to contain minimal dependencies, ensuring long-term efficiency and stability. Future work could involve extending this methodology to additional microscopy datasets and performing detailed studies of real-time laboratory deployment. This automated pipeline represents a significant step toward fully automated materials characterization, reducing human intervention in routine preprocessing tasks and accelerating data acquisition.

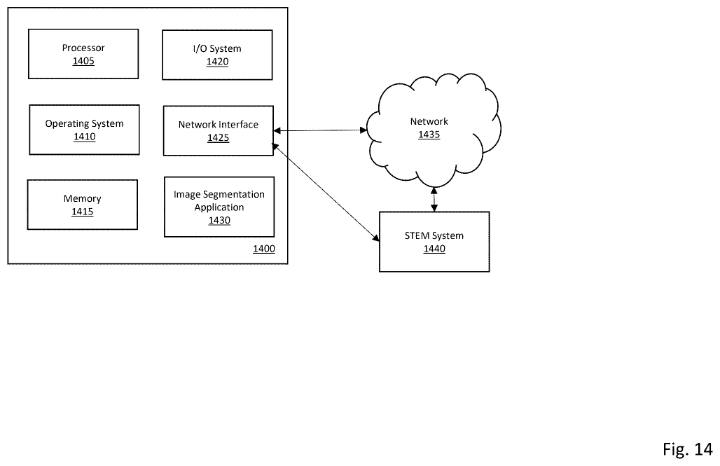

In an illustrative embodiment, any of the operations described herein can be performed by a computing system that includes a memory, processor, user interface, network interface, display, etc. For example, any of the operations described herein can be implemented as computer-readable instructions stored on a computer-readable medium. Upon execution of the computer-readable instructions by the processor, the computing system performs the various operations described herein to implement the system. As an example, FIG. 14 depicts a computing device 1400 in direct or indirect communication with a network 1435 in accordance with an illustrative embodiment. The computing device 1400 is in communication with a STEM system 1440, either directly or through the network 1435. The STEM system 1440 can be any type of nanoparticle characterization device, such as a Four-Dimensional Scanning Transmission Electron Microscopy (4D-STEM) system, an Energy Dispersive X-ray Spectroscopy (EDS) system, an Electron Energy Loss Spectroscopy (EELS) system, etc. In one embodiment, the computing device 1400 can be incorporated into the STEM system 1440. In other embodiments, the computing device 1400 can be a smartphone, tablet, laptop computer, desktop computer, etc.

The computing device 1400 includes a processor (or microcontroller) 1405, an operating system 1410, a memory 1415, an input/output (I/O) system 1420, a network interface 1425, and an image segmentation application 1430. In alternative embodiments, the computing device 1400 may include fewer, additional, and/or different components. The components of the computing device 1400 communicate with one another via one or more buses or any other interconnect system.

The processor 1405 of the computing device 1400 can be in electrical communication with and used to control any of the systems described herein, such as a microscopy system, a spectroscopy system, etc. The processor 1405 can be any type of computer processor known in the art, and can include a plurality of processors and/or a plurality of processing cores. The processor 1405 can include a controller, a microcontroller, an audio processor, a graphics processing unit, a hardware accelerator, a digital signal processor, etc. Additionally, the processor 1405 may be implemented as a complex instruction set computer processor, a reduced instruction set computer processor, an x86 instruction set computer processor, etc. The processor 1405 is used to run the operating system 1410, which can be a custom operating system specific to the requirements of the proposed system.

The operating system 1410 is stored in the memory 1415, which is also used to store programs, image data, algorithms, network and communications data, peripheral component data, and other operating instructions. The memory 1415 can be one or more memory systems that include various types of computer memory such as flash memory, random access memory (RAM), dynamic (RAM), static (RAM), a universal serial bus (USB) drive, an optical disk drive, a tape drive, an internal storage device, a non-volatile storage device, a hard disk drive (HDD), a volatile storage device, etc.

The I/O system 1420, or user interface, is the framework which enables users (and peripheral devices) to interact with the computing device 1400. The I/O system 1420 can include one or more keys or a keyboard, one or more buttons, one or more displays, a speaker, a microphone, etc. that allow the user to interact with and control the computing device 1400. The I/O system 1420 also includes the on/off switch, LED indicator lights, etc. The I/O system 1420 further includes circuitry and a bus structure to interface with peripheral computing components such as power sources, sensors, etc.

The network interface 1425 includes transceiver circuitry that allows the computing device 1400 to transmit and receive data to/from other devices such as user device(s), remote computing systems, imaging systems, servers, websites, etc. The network interface 1425 enables communication through the network 1435, which can be one or more communication networks. The network 1435 can include a cable network, a fiber network, a cellular network, a wi-fi network, a landline telephone network, a microwave network, a satellite network, etc. The network interface 1425 also includes circuitry to allow device-to-device communication such as near field communication (NFC), Bluetooth® communication, etc.

The image segmentation application 1430 can include hardware, software, and algorithms (e.g., in the form of computer-readable instructions) which, upon activation or execution by the processor 1405, performs any of the various operations described herein such as receiving images, identifying regions of interest in the images, identifying and excluding backgrounds of the images, identifying morphological features of the images, downsizing the resolution of the images, applying a sharpening mask to the images, applying a Gaussian blur to the images, applying a binary mask that results from Gaussian thresholding, generating a bounding box for a nanoparticle in the images, identifying child images, labeling images, identifying a cutoff value based on pixel intensity, performing clustering, performing other pre-processing operations on the images, performing image segmentation, placing adaptively sized boxes on the image, identifying acquisition coordinates, conducting nanoparticle characterization using the acquisition coordinates (e.g., using a STEM system), etc. The image segmentation application 1430 can utilize the processor 1405 and/or the memory 1415 as discussed above.

In one embodiment, the image segmentation application 1430 can be implemented as software that segments nanoparticle images using unsupervised clustering and computer vision techniques. As discussed herein, the software identifies and removes the background from the image, segments the particle into regions of interest using 1D k-means clustering, and uses an algorithm to find and return adaptively-sized regions (e.g., squares) that fully fill the regions identified during clustering. These squares can then be used for downstream processing techniques, such as 4D-STEM. Relative to existing approaches, which do not involve background removal or image segmentation, the proposed pipeline is optimized to only return information that is relevant to downstream processing. The proposed technique is projected to operate much faster on average than existing approaches, and to require less storage space. These benefits are expected to translate into faster turnaround times for users of STEM microscopes and to remove the requirement for human involvement in the process.

There are no specific hardware requirements for this software beyond a standard laptop, desktop machine, or other computing device. For real-time use in a laboratory setting, the proposed system can access or otherwise interact with a STEM microscope with Python integration, such as GATAN. The current code utilizes Python version 3.8.18, SciPy 1.10.1, OpenCV 4.5.5, scikit-image 0.19.3, and Matplotlib 3.7.2. In alternative embodiments, different applications may be used and/or accessed by the code.

In summary, described herein is an automated image processing pipeline that optimizes high-throughput nanoparticle characterization using intelligent image segmentation and coordinate generation. The proposed methods and systems can rapidly analyze each image and return optimized acquisition coordinates suitable for multiple analytical STEM techniques, including 4D-STEM, EELS, and EDS. The pipeline employs computer vision and unsupervised learning to remove the image background, segment the particle into areas of interest, and generate acquisition coordinates. This approach eliminates the need for uniform grid sampling, focusing data collection on regions of interest. As discussed, the inventors validated the approach using a diverse dataset of over 900 high-resolution grayscale nanoparticle images, achieving a 96.0% success rate based on expert-validated criteria. Using established 4D-STEM acquisition times as a baseline, the method demonstrates a 25.0 to 29.1-fold reduction in total processing time. By automating this crucial preprocessing operation and optimizing data acquisition, the pipeline significantly accelerates materials characterization workflows while reducing unnecessary data collection.

The word “illustrative” is used herein to mean serving as an example, instance, or illustration. Any aspect or design described herein as “illustrative” is not necessarily to be construed as preferred or advantageous over other aspects or designs. Further, for the purposes of this disclosure and unless otherwise specified, “a” or “an” means “one or more.”

The foregoing description of illustrative embodiments of the invention has been presented for purposes of illustration and of description. It is not intended to be exhaustive or to limit the invention to the precise form disclosed, and modifications and variations are possible in light of the above teachings or may be acquired from practice of the invention. The embodiments were chosen and described in order to explain the principles of the invention and as practical applications of the invention to enable one skilled in the art to utilize the invention in various embodiments and with various modifications as suited to the particular use contemplated. It is intended that the scope of the invention be defined by the claims appended hereto and their equivalents.

1. A system to perform image processing and segmentation, the system comprising:
a memory configured to store an image of a nanoparticle; and
a processor operatively coupled to the memory, wherein the processor is configured to:
identify a background of the image, wherein the background includes one or more portions of the image that do not depict the nanoparticle;
remove the background from the image with a mask;
apply clustering to the image to identify regions of interest in the image; and
identify acquisition boxes in each of the identified regions of interest.

2. The system of claim 1, wherein the processor determines a cutoff value, and wherein the background of the image is identified based on the cutoff value.

3. The system of claim 2, wherein the processor analyzes pixel intensities of the image, and wherein the cutoff value is determined based on the pixel intensities.

4. The system of claim 3, wherein the pixel intensities are determined along a line that runs diagonally across the image.

5. The system of claim 1, wherein the mask comprises an updated binary mask.

6. The system of claim 5, wherein the processor determines a convex hull of an original binary mask for the image, and wherein the updated binary mask is generated based on the convex hull of the original binary mask.

7. The system of claim 6, wherein the processor applies a sharpening mask to a resized version of the image to form a sharpened image, and wherein the processor applies a Gaussian blur to the sharpened image.

8. The system of claim 1, wherein the processor applies Gaussian thresholding to the image to generate a bounding box for the nanoparticle, and wherein the processor crops the image based on the bounding box.

9. The system of claim 1, wherein the clustering comprises k-means clustering, and wherein the clustering is performed based on a number of intensity peaks identified in the image.

10. The system of claim 1, wherein the acquisition boxes comprise squares that completely fill each of identified regions of interest.

11. The system of claim 1, wherein the system uses the acquisition boxes to determine acquisition coordinates for analysis of the nanoparticle.

12. The system of claim 11, further comprising a scanning transmission electron microscope in communication with the processor, wherein the scanning transmission electron microscope uses the acquisition coordinates to generate a characterization of the nanoparticle.

13. A method of performing image processing and segmentation, the method comprising:
storing, in a memory of a computing system, an image of a nanoparticle;
identifying, by a processor of the computing system, a background of the image, wherein the background includes one or more portions of the image that do not depict the nanoparticle;
removing, by the processor, the background from the image with a mask;
applying, by the processor, clustering to the image to identify regions of interest in the image; and
identifying, by the processor, acquisition boxes in each of the identified regions of interest.

14. The method of claim 13, further comprising determining, by the processor, a cutoff value, wherein the background of the image is identified based on the cutoff value.

15. The method of claim 14, further comprising analyzing, by the processor, pixel intensities of the image, wherein the cutoff value is determined based on the pixel intensities.

16. The method of claim 15, further comprising determining, by the processor, the pixel intensities along a line that runs diagonally across the image.

17. The method of claim 13, further comprising applying, by the processor, Gaussian thresholding to the image to generate a bounding box for the nanoparticle, and cropping the image based on the bounding box.

18. The method of claim 13, wherein the clustering comprises k-means clustering, and further comprising performing the clustering based on a number of intensity peaks identified in the image.

19. The method of claim 13, further comprising determining, based on the acquisition boxes, acquisition coordinates for analysis of the nanoparticle.

20. The method of claim 19, further comprising generating, by a scanning transmission electron microscope in communication with the processor and based on the acquisition coordinates, a characterization of the nanoparticle.
